(19) United States
(12) Patent Application Publication
(10) Pub. No.: US 2026/0061528 A1
(43) Pub. Date: Mar. 5, 2026

(54) FLUX COMPOSITION

(71) Applicant: HONEYWELL INTERNATIONAL INC., Charlotte, NC (US)

(72) Inventors: Jurgen Friederich Rudolph, Peine (DE); Alfred Siggel, Seelze (DE)

(73) Assignee: HONEYWELL INTERNATIONAL INC., Charlotte, NC (US)

(21) Appl. No.: 19/279,774

(22) Filed: Jul. 24, 2025

Related U.S. Application Data
(60) Provisional application No. 63/690,999, filed on Sep. 5, 2024.

(51) Int. Cl. B23K 35/36; B23K 1/20; B23K 35/02; B23K 35/362

(52) U.S. Cl. CPC B23K 35/3605; B23K 1/203; B23K 35/025; B23K 35/362

(57) ABSTRACT

A flux composition includes a flux agent including KAlF4 and CsAlF4; a thickening agent having a first carbon content; a binder having a second carbon content; and an organic solvent; wherein a total carbon content of the flux composition is less than about 1 wt %, based on a total weight of the flux composition. The flux composition is applied onto a substrate by jetting the flux composition through a nozzle orifice of an applicator and onto the substrate.

### CROSS-REFERENCE TO RELATED APPLICATION

This application claims the benefit of U.S. Provisional application No. 63/690,999, filed on Sep. 5, 2024, the entire content of which is hereby incorporated by reference.

### TECHNICAL FIELD

The present disclosure generally relates to a flux composition and a method of applying the flux composition onto a substrate. More specifically, the flux composition includes a flux agent that is a combination of KAlF₄ and CsAlF₄, and has a carbon content of less than about 1 wt %, based on a total weight of the flux composition.

### BACKGROUND

Brazing operations, which are used in various manufacturing processes, such as in heat exchanger manufacturing, have traditionally been carried out in vacuum furnaces. Recently, a brazing technique known as “controlled atmosphere brazing” (CAB) has become accepted by the automotive industry for making brazed aluminum heat exchangers including radiators, condensers, evaporators, heater cores, air charged coolers and intercoolers. CAB is industrially preferred over vacuum furnace brazing due to improved production yields, lower furnace maintenance requirements, greater braze process robustness and lower capital costs.

In a typical CAB process, a flux composition is applied to the surface of a pre-assembled component to be brazed. In the case of components including aluminum and aluminum alloy parts, the flux composition is typically used to dissociate or dissolve an aluminum oxide layer that naturally forms on aluminum and aluminum alloy surfaces. The flux agent can also be used to reduce reformation of the aluminum oxide layer during brazing and to enhance the flow of brazing alloys. Typical flux agents include alkaline metal or alkaline earth metal fluorides or chlorides. Flux compositions including fluoride flux agents are generally preferred for brazing aluminum or aluminum alloy substrates.

Many existing flux compositions include a high amount of rheology additives, which generally allows the flux compositions to attain certain physical properties desirable for various applications. However, these rheology additives often have a high carbon content. When used in flux compositions, these additives tend to decompose during brazing and leave large amounts of carbon black residue on braze joints which can weaken the joints. Accordingly, there remains an opportunity for improvement.

### BRIEF SUMMARY

This disclosure provides a flux composition that includes:
a flux agent that is a combination of KAlF₄ and CsAlF₄;
a thickening agent having a first carbon content;
a binder having a second carbon content; and
an organic solvent;
wherein a total carbon content of the flux composition is less than about 1 wt %, based on a total weight of the flux composition, measured using combustion analysis.

This disclosure additionally provides a method of applying the flux composition onto a substrate, wherein the method includes the steps of:
a) providing the substrate;
b) providing an applicator including a nozzle defining a nozzle orifice that has a nozzle diameter of from about 0.1 to about 2 mm;
c) providing the flux composition; and
d) jetting the flux composition through the nozzle orifice and onto the substrate.

### BRIEF DESCRIPTION OF THE DRAWINGS

The present disclosure will hereinafter be described in conjunction with the following drawing figures, wherein:

FIG. 1 is a line graph of viscosity, reported in the y-axis and in a unit of mPas, as a function of solids content, reported in the x-axis and in a unit of wt %, of a flux agent including KAlF₄ in water;

FIG. 2 is a line graph of viscosity, reported in the y-axis and in a unit of mPas, as a function of amount of CsAlF₄, reported in the x-axis and in a unit of wt %, of a flux agent including KAlF₄ and CsAlF₄ in water;

FIG. 3 is a line graph of particle size distributions (PSD) Dv50 and Dv90, reported in the y-axis and in a unit of micron, as a function of milling time, reported in the x-axis and in a unit of minute, of a flux agent including KAlF₄ and CsAlF₄;

FIG. 4 is a line graph of diameter of dots, reported in the y-axis and in a unit of mm, and formed by jetting the flux composition 22 of the Examples onto an aluminum substrate as a function of viscosity, reported in the x-axis and in a unit of mPas, of the flux composition;

FIG. 5 is a line graph of weight of 1000 dots, reported in the y-axis and in a unit of mg, formed by jetting the flux composition 22 of the Examples onto an aluminum substrate as a function of viscosity, reported in the x-axis and in a unit of mPas, of the flux composition;

FIG. 6 is a photograph of printed dots and lines formed by jetting flux composition 15 of the Examples onto an aluminum substrate;

FIG. 7A is a photograph of printed lines formed by jetting flux composition 16 of the Examples onto an aluminum substrate;

FIG. 7B is a photograph of printed dots formed by jetting flux composition 16 of the Examples onto an aluminum substrate;

FIG. 8 is a photograph of printed dots and lines made by jetting flux composition 22 of the Examples onto an aluminum substrate;

FIG. 9 is a photograph of three articles, each formed by brazing three aluminum substrates together, after using flux compositions 9 to 11 of the Examples, respectively from left to right, as the flux composition;

FIG. 10 is a photograph of five articles, each formed by brazing two aluminum substrates together, after using flux compositions 18 to 21 of the Examples, respectively from top to bottom and left to right, as the flux composition;

FIG. 11 is a side perspective view of an embodiment of the flux composition disposed on a surface of a substrate;

FIG. 12 is a side perspective view of an embodiment of an applicator used to jet the flux composition; and

FIG. 13 is a side perspective view of an embodiment of a system for applying the flux composition to the surface of the substrate utilizing the applicator.

### DETAILED DESCRIPTION

The following detailed description is merely exemplary in nature and is not intended to limit the current composition. Furthermore, there is no intention to be bound by any theory presented in the preceding background or the following detailed description.

Embodiments of the present disclosure are generally directed to flux compositions and methods for applying the same. For the sake of brevity, conventional techniques related to making such compositions may not be described in detail herein. Moreover, the various tasks and process steps described herein may be incorporated into a more comprehensive procedure or process having additional steps or functionality not described in detail herein. In particular, various steps in the manufacture of compositions are well-known and so, in the interest of brevity, many conventional steps will only be described briefly herein or will be omitted entirely without providing the well-known process details.

In this disclosure, the terminology “about” can describe values ±0.1, 0.5, 1, 2, 3, 4, 5, 6, 7, 8, 9, or 10%, in various embodiments. Moreover, it is contemplated that, in various non-limiting embodiments, it is to be appreciated that all numerical values as provided herein, save for the actual examples, are approximate values with endpoints or particular values intended to be read as “about” or “approximately” the value as recited. It is also contemplated that all isomers and chiral options for each compound described herein are hereby expressly contemplated for use herein in various non-limiting embodiments.

In various embodiments, the terminology “free of” describes embodiments that include less than about 5, 4, 3, 2, 1, 0.5, or 0.1, weight percent (wt %) of the compound or element at issue using an appropriate weight basis as would be understood by one of skill in the art. In other embodiments, the terminology “free of” describes embodiments that have zero weight percent of the compound or element at issue.

The terminology “consists essentially of” may describe various non-limiting embodiments that are free of one or more optional compounds described herein and/or free of one or more polymers, surfactants, additives, solvents, etc.

It is to be understood that the subscripts of polymers are typically described as average values because the synthesis of polymers typically produces a distribution of various individual molecules.

The flux compositions disclosed herein may suitably comprise, consist of, or consist essentially of the components, elements, and process delineations described herein. The embodiments illustratively disclosed herein suitably may be practiced in the absence of any element which is not specifically disclosed herein.

### Flux Composition

In brazing processes, two or more metal substrates can be connected by various techniques to create a joint. A flux composition is typically employed before brazing to facilitate the connection of the metal substrates and creation of such joints. The flux composition can serve several purposes, including cleaning the metal substrates, reducing potential oxidation, and/or promoting flow of any filler metals. Components used in flux compositions may vary depending on the metal substrates, methods of application and methods of melting filler metals.

The disclosure describes a flux composition having a low carbon content, as described in greater detail below. The flux composition includes:
a flux agent that is a combination of KAlF₄ and CsAlF₄;
a thickening agent having a first carbon content;
a binder having a second carbon content; and
an organic solvent;
wherein a total carbon content of the flux composition is less than about 1 wt %, based on a total weight of the flux composition, measured using combustion analysis.

### Flux Agent

The flux composition includes the flux agent, which may be described as an active compound as known in the art. The flux agent is a combination of aluminum potassium fluoride (KAlF₄) and aluminum cesium fluoride (CsAlF₄). Compared to KAlF₄, CsAlF₄ can dissolve more readily in water. The CsAlF₄ can increase the viscosity of the flux composition. Accordingly, using a combination of KAlF₄ and CsAlF₄ as the flux agent can help customize the viscosity of the flux composition without using a substantial amount of rheology additives that is otherwise needed to attain the desired viscosity. For example, the flux composition may include less than about 5 wt %, or less than about 4 wt %, or less than about 3 wt %, or less than about 2 wt %, or less than about 1 wt % of rheology additives, based on a total weight of the flux composition. Alternatively, 0 wt % of rheology additives may be included in the flux composition.

The combined amount of KAlF₄ and CsAlF₄ adds to 100 wt % of the flux agent. Typically, CsAlF₄ is present in the flux agent in an amount of from about 1 to about 30 wt %, based on a total weight of the flux agent. In various embodiments, CsAlF₄ is present in amount of from about 1 to about 30 wt %, about 2 to about 29 wt %, about 3 to about 28 wt %, about 4 to about 27 wt %, about 5 to about 26 wt %, about 5 to about 25 wt %, about 6 to about 24 wt %, about 7 to about 23 wt %, about 8 to about 22 wt %, about 9 to about 21 wt %, about 10 to about 20 wt %, about 11 to about 19 wt %, about 12 to about 18 wt %, about 13 to about 17 wt %, or about 14 to about 16 wt %. In various non-limiting embodiments, all values and ranges of values including and between those set forth above are expressly contemplated for use herein.

Accordingly, KAlF₄ is typically present in the flux agent in an amount of from about 70 to about 99 wt %, based on a total weight of the flux agent. In various embodiments, CsAlF₄ is present in amount of from about 70 to about 99 wt %, about 71 to about 98 wt %, about 72 to about 97 wt %, about 73 to about 96 wt %, about 74 to about 95 wt %, about 75 to about 95 wt %, about 76 to about 94 wt %, about 77 to about 93 wt %, about 78 to about 92 wt %, about 79 to about 91 wt %, about 80 to about 90 wt %, about 81 to about 89 wt %, about 82 to about 88 wt %, about 83 to about 87 wt %, or about 84 to about 86 wt %. In various non-limiting embodiments, all values and ranges of values including and between those set forth above are expressly contemplated for use herein.

The amount of the flux agent present in the flux composition can affect the efficiency of the flux composition, e.g. efficiency in cleaning the metal substrates for brazing. The flux agent is typically present in the flux composition in an amount of from about 40 to about 50 wt %, based on a total weight of the flux composition. In various embodiments, the flux agent is present in an amount of from about 40 to about 50 wt %, about 41 to about 49 wt %, about 42 to about 48 wt %, about 43 to about 47 wt %, or about 44 to about 46 wt %. In various non-limiting embodiments, all values and ranges of values including and between those set forth above are expressly contemplated for use herein.

In various embodiments, the flux agent may or may not undergo a micronization process to reduce its particle size to suit the needs of different applications. The flux agent may be micronized with or without other components including any rheology additives, organic solvent and water to help reduce undesirable friction that occurs during the micronization process. The micronization process may be performed using any method known in the art. Such methods may be traditional methods such as mechanical milling. Additionally, any oversized particles can be isolated and re-milled. Alternatively, annular gap bead mills may be used to transfer more energy and provide a more effective micronization compared to traditional methods. In one embodiment, the flux agent is micronized using a Netzsch Laboratory Agitator Bead Mill LabStar annular gap bead mill.

The flux composition may include the flux agent as the only flux capable compound. Alternatively, the flux composition may include the flux agent and an additional flux compound. Therefore, the flux composition may or may not include the additional flux compound, which may be any known in the art, such as another alkaline metal or alkaline earth metal fluoride or chloride, that may be hydrated or non-hydrated, may or may not include an oxygen atom, may or may not include a hydroxy group, and may or may not include more than one alkaline or alkaline earth metal. Non limiting examples of additional flux compounds include aluminum fluoride (AlF₃), cesium fluoride (CsF), rubidium fluoride (RbF), lithium fluoride (LiF), sodium fluoride (NaF), calcium fluoride (CaF₂), potassium pentafluoro aluminate (K₂AlF₅, K₂AlF₅·H2O), potassium hexafluoro aluminate (K₃AlF₆), oxyfluoro aluminum (Al₂F₄O, AlFO), hydrofluoro aluminum (AlF₂(OH), AlF₂(OH)·H₂O, AlF(OH)₂, potassium tetrafluoroborate (KBF₄), sodium tetrafluoroborate (NaBF₄), potassium trifluoro zincate (KZnF₃), potassium tetrafluoro zincate (K₂ZnF₄), cesium trifluoro zincate (CsZnF₃), cesium tetrafluoro zincate (Cs₂ZnF₄), cesium hexafluoro silicate (Cs₂SiF₆), potassium hexafluoro silicate (K₂SiF₆), lithium hexafluoro silicate (Si₂SiF₆), rubidium hexafluoro silicate (Rb₂SiF₆), sodium hexafluoro silicate (Na₂SiF₆), ammonium hexafluoro silicate ((NH₄)₂SiF₆) potassium cesium hexafluoro silicate (KCsSiF₆), lithium cesium hexafluoro silicate (LiCsSiF₆), rubidium cesium hexafluoro silicate (RbCsSiF₆), rubidium potassium hexafluoro silicate (RbKSiF₆), ammonium cesium hexafluoro silicate (NH₄CsSiF₆), cesium hydro fluorosilicate (CsHSiF₆), potassium hydro fluorosilicate (KHSiF₆), lithium hydro fluorosilicate (LiHSiF₆), ammonium hydro fluorosilicate (NH₄HSiF₆), cesium fluoride (CsF), cesium hexafluoro aluminate (Cs₃AlF₆), cesium tetrafluoro aluminate (CsAlF₄·H₂O), cesium pentafluoro aluminate (CsAlF₅, CsAlF₅·H₂O), and combinations thereof.

The additional flux compound can be present in the flux composition in an amount of from about 0 and up to about 5 wt %. In various embodiments, the additional flux compound is present in amount of from about 0 and up to about 5 wt %, about 0.5 to about 4.5 wt %, about 1 to about 4 wt %, about 1.5 to about 3.5 wt %, or about 2 to about 3 wt %. In various non-limiting embodiments, all values and ranges of values including and between those set forth above are expressly contemplated for use herein.

### Thickening Agent

Using the combination of KAlF₄ and CsAlF₄ as the flux agent can help customize the viscosity of the flux composition. However, the flux composition also includes the thickening agent to help finetune the viscosity of the flux composition. The thickening agent is typically used to increase viscosity and/or provide sheer thinning properties to the flux composition. Generally, an increase in viscosity caused by the presence of the thickening agent can also enhance adhesion of the flux composition onto the metal substrates, help reduce splattering of any filler metals during brazing and help minimize settling and agglomeration of solids in the flux composition. The thickening agent can be any known in the art, such as an organic polymer, including but not limited to cellulose ethers, polysaccharides such as diutan, xanthan gum, etc., polyacrylates such as acrylate copolymer, methacrylate copolymer, etc. and combinations thereof. In one embodiment, the thickening agent is diutan. In another embodiment, the thickening agent is xanthan gum. In yet another embodiment, the thickening agent is a combination of diuatan and xanthan gum.

The thickening agent may be present in the flux composition in an amount of from greater than about 0 and up to about 0.4 wt %, based on a total weight of the flux composition. In various embodiments, the thickening agent is present in an amount of from about great than 0 and up to about 0.2 wt %, about 0.1 to about 0.2 wt %, about 0.11 to about 0.19 wt %, about 0.12 to about 0.18, about 0.13 to about 0.17, or about 0.14 to about 0.16, based on a total weight of the flux composition. In other embodiments, the thickening agent is present in an amount of from about 0.2 to about 0.4 wt %, about 0.21 to about 0.39 wt %, about 0.22 to about 0.38 wt %, about 0.23 to about 0.37 wt %, about 0.24 to about 0.36 wt %, about 0.25 to about 0.35 wt %, about 0.26 to 0.34 wt %, about 0.27 to about 0.33 wt %, about 0.28 to about 0.32 wt %, about 0.29 to about 0.31 wt %, or about 0.29 to about 0.3 wt %, based on a total weight of the flux composition. In various non-limiting embodiments, all values and ranges of values including and between those set forth above are expressly contemplated for use herein.

The thickening agent may also be described as a non-volatile organic compound having a first carbon content. The first carbon content may be measured using any method known in the art, e.g. wet oxidation, combustion analysis, etc. For example, the first carbon content may be measured using combustion analysis, performed with an elemental analyze, which uses a combustion furnace to heat a sample including the thickening agent to a high temperature, e.g about 900 to about 1000° C. Carbon in the sample can be converted to carbon dioxide and may be quantified using a detector, e.g. an infrared detector and calculated as a wt % of the initial weight of the sample.

The first carbon content, measured using any of the aforementioned methods, may be greater than about 0 and up to about less than 1 wt %, based on a total weight of the composition. In various embodiments, the first carbon content is from about 0.05 to about 0.95 wt %, about 0.1 to about 0.9 wt %, about 0.15 to about 0.85 wt %, about 0.2 to about 0.8 wt %, about 0.25 to about 0.75 wt %, about 0.3 to about 0.7 wt %, about 0.35 to about 0.65 wt %, about 0.4 to about 0.6 wt %, about 0.45 to about 0.55 wt %, based on a total weight of the flux composition. In various non-limiting embodiments, all values and ranges of values including and between those set forth above are expressly contemplated for use herein.

### Binder

The flux composition also includes the binder. Similar to the thickening agent, the binder is typically used to help attain a desired viscosity and other physical properties of the flux composition. The presence of the binder in the flux composition can additionally promote adhesion between the flux composition and the metal substrates.

The binder can be any known in the art, and may have a variety of solids content, pH, and viscosity. The binder may be or includes a polyacrylate, including but not limited to ALBERDINGK: AC 3600, Weckerle: weco-Fan binder, Synthomer: Plextol, Allnex: Setaqua, Vinavil: Crilat, Synthomer: Revacrayl, Celanese: Mowilith, Celanese: Vinacryl, Covestro: Bayhydrol, D&R Dispersions and Resins: Akryvil, Dex-Vin Polymers: Dexicryl, Diransa: Thyosil, Dynea: Dilexo, Evonik: Hybridur, Icap Sira: Acrilem, Ingevity: Jonrez, Iffco Chemicals: AquaCril, Lubrizol: Carboset, etc. In one embodiment, the binder is ALBERDINGK® AC 3600. In another embodiment, the binder is a weco-Fan binder. In yet another embodiment, the binder is a combination of ALBERDINGK® AC 3600 and a weco-Fan binder.

The binder may be present in the flux composition in an amount of from greater than about 0 and up to about 5 wt %, based on a total weight of the flux composition. In various embodiments, the binder is present in an amount of from about 0.1 to about 0.5 wt %, about 0.15 to about 0.45 wt %, about 0.2 to about 0.4 wt %, about 0.25 to about 0.35 wt %, or about 0.25 to about 0.3 wt %, based on a total weight of the flux composition. In various other embodiments, the binder is present in an amount of from about 0.5 to about 2 wt %, about 0.6 to about 1.9 wt %, about 0.7 to about 1.8 wt %, about 0.8 to about 1.7 wt %, about 0.9 to about 1.6 wt %, about 1 to about 1.5 wt %, about 1.1 to about 1.4 wt %, or about 1.2 to about 1.3 wt %, based on a total weight of the flux composition. In yet other embodiments, the binder is present in an amount of from about 2 to about 5 wt %, about 2.5 to about 4.5 wt %, about 3 to about 4 wt %, or about 3 to about 3.5 wt %, based on a total weight of the composition. In various non-limiting embodiments, all values and ranges of values including and between those set forth are expressly contemplated for use therein.

The binder may also be described as a non-volatile organic compound having a second carbon content. The second carbon content, which may be measured using any methods first mentioned above, may be greater than about 0 and up to about less than 1 wt %, based on a total weight of the composition. In various embodiments, the second carbon content is from about 0.05 to about 0.95 wt %, about 0.1 to about 0.9 wt %, about 0.15 to about 0.85 wt %, about 0.2 to about 0.8 wt %, about 0.25 to about 0.75 wt %, about 0.3 to about 0.7 wt %, about 0.35 to about 0.65 wt %, about 0.4 to about 0.6 wt %, about 0.45 to about 0.55 wt %, based on a total weight of the flux composition. In various non-limiting embodiments, all values and ranges of values including and between those set forth above are expressly contemplated for use herein.

### Organic Solvent

The flux composition also includes the organic solvent, which is typically employed as a carrier for solid components such as the flux agent, the thickening agent and the binder. The presence of the organic solvent can help increase wetting ability of the flux composition and promote adhesion of the flux composition to the metal substrates, which can help reduce or even eliminate a need for an organic surfactant. For example, the organic surfactant may be present in the flux composition in an amount of less than about 5 wt %, or less than about 4 wt %, or less than about 3 wt %, or less than about 2 wt %, or less than about 1 wt %, or about 0%, based on a total weight of the flux composition. In various non-limiting embodiments, all values and ranges of values including and between those set forth above are expressly contemplated for use herein.

The organic solvent can be any known in the art, e.g. it may have 1 to 20 carbons, and may be polar or non-polar, aromatic or non-aromatic, branched or unbranched, substituted or non-substituted. Suitable organic solvents include solvents that are known in the art to exhibit a high boiling point, e.g. greater than about 100° C., greater than about 150° C., greater than about 200° C., greater than about 250° C., etc., and a high flash point, e.g. greater than about 50° C., greater than about 60° C., greater than about 70° C., greater than about 80° C., etc. Examples of these organic solvents include, but are not limited to, propylene carbonate, propylene glycol, hexylene glycol, dioxane, 3-methoxy-3-methyl-1-butanol, texanol, butyl glycol, butyl diglycol, butyl triglycol, etc. In various embodiments, the organic solvent is 3-methoxy-3-methyl-1-butanol, butyl glycol, propylene carbonate, or combinations thereof. In various non-limiting embodiments, all values and ranges of values including and between those set forth above are expressly contemplated for use herein.

The organic solvent may be present in an amount of from greater than about 0 and up to about 50 wt %, based on a total weight of the flux composition. In various embodiments, the organic solvent is present in an amount of from about greater than about 0 and up to about 10 wt %, about 1 to about 10 wt %, about 2 to about 9 wt %, about 3 to about 8 wt %, about 4 to about 7 wt %, about 5 to about 6 wt %, based on a total weight of the flux composition. In other embodiments, the organic solvent is present in an amount of from about 1 to about 3 wt %, about 1.5 to about 2.5 wt %, about 1 to about 1.5 wt %, about 1 to about 2 wt %, about 2 to about 3 wt %, based on a total weight of the flux composition. In yet other embodiments, the organic solvent is present in an amount of from about 10 to about 50 wt %, about 15 to about 45 wt %, about 20 to about 40 wt %, about 25 to about 35 wt %, ot about 25 to about 30 wt %, based on a total weight of the flux composition. In various non-limiting embodiments, all values and ranges of values including and between those set forth are expressly contemplated for use therein.

In various embodiments, the organic solvent is or includes texanol. Texanol may be further described as texanol ester alcohol, trimethyl hydroxypentyl isobutyrate, issobutyric acid, ester alcohol, 2,2,4-trimethyl-1,3-pentanediol monoisobutyrate, etc. The texanol may be used in the flux composition for various purposes, e.g. to reduce drying speed and/or improve nozzle clogging.

In other embodiments, the texanol is present in the flux composition in an amount of from about 1 to about 2 wt %, alternatively from about 1 to about 1.5, about 1.5 to about 2, about 1.1 to about 1.9, about 1.2 to about 1.8, about 1.3 to about 1.7, or about 1.4 to about 1.6, wt %, based on a total weight of the flux composition. In various non-limiting embodiments, all values and ranges of values including and between those set forth are expressly contemplated for use therein.

### Water:

The flux composition may or may not additionally include water. Water may be from a variety of sources, e.g. commercially obtained water, tap water, filtered water, water as a part of other components including the binder, the thickening agent, the organic solvent, optional rheology additives, and combinations thereof. Typically, water is included in the flux composition to dissolve the flux agent, the binder and the thickening agent, and attain the desired viscosity. This dissolution can help create a homogeneous mixture and increase uniformity of the flux composition, thereby increasing the effectiveness of the flux composition for brazing. For certain applications, water may also be used to attain suitable flow properties of the flux composition. A large amount of water, e.g. greater than about 10 wt % based on a total weight of the flux composition, may facilitate better flow of the flux composition in various applications but can also decrease brazing effectiveness of the flux composition. In contrast, a small amount of water, e.g. less than about 10 wt % based on a total weight of the composition, may lead to an increase in agglomeration of solid components.

Water may be present in the flux composition in an amount of from about 0 to about 50 wt %, based on a total weight of the flux composition. In various embodiments, water is present from about 0 to about 50 wt %, about 1 to about 45, about 5 to about 40, about 5 to about 35 wt %, about 10 to about 30 wt %, or about 15 to about 25 wt %, based on a total weight of the flux composition. In other embodiments, water is present from about 1 to about 9 wt %, about 2 to 8 wt %, about 3 to 7 wt %, or about 4 to 6 wt %, based on a total weight of the flux composition. In yet other embodiments, water is present from about 20 to about 50 wt %, about 25 to about 45 wt %, about 30 to about 40 wt %, or about 30 to about 25 wt %, based on a total weight of the flux composition. In various non-limiting embodiments, all values and ranges of values including and between those set forth are expressly contemplated for use therein.

### Additional Compounds:

The flux composition may or may not include additional compounds in addition to those described above. For example, the flux composition may include an additional organic rheology additive, such as a crystallization inhibitor, a dispersant, a wetting agent, a defoamer, a biocide agent, etc. The organic rheology additive can be used to achieve different rheology properties of the flux composition suitable for different application needs.

Suitable crystallization inhibitors may be any known in the art, including, but not limited to, a modified ethylene-vinyl acetate copolymer wax such as BYK: AQUACER® 526, a modified urea such as BYK: BYKETOL®-PC, glycerin, ethylene glycol, a polyethylene glycol (PEG) such as PEG 400, PEG 1000, PEG 10000, PEG 20000, etc., polyethylene glycol sorbitan monolaurate (TWEEN® 20), polyoxyethylene sorbitan monopalmitate (TWEEN® 40), sorbitan monooleate (TWEEN® 80), propylene glycol, polypropylene glycol such as PPG 400, PPG 2000, PEG-PPG copolymers, PLA-PEG copolymers, etc. In various embodiments, the flux composition further includes glycerin, PEG 400, modified ethylene/vinyl acetate copolymer, modified urea, or combinations thereof.

The crystallization inhibitor may be present in an amount of from about 0 to about 0.5 wt %, based on a total weight of the flux composition. In various embodiments, the crystallization inhibitor is present in an amount of from 0 to about 0.5 wt %, about 0.1 to about 0.4, or about 0.2 to about 0.3 wt %, based on a total weight of the flux composition. In various non-limiting embodiments, all values and ranges of values including and between those set forth are expressly contemplated for use therein.

Suitable dispersants may be any known in the art, including, but not limited to, BYK: Disperbyk® block copolymer, acrylates, polyurethanes, polyalkoxylates, fatty acids and phosphoric acids derivatives, etc. In one embodiment, the flux composition further includes Disperbyk®-190 block copolymer.

The dispersant may be present in an amount of from about 0 to about 0.5 wt %, based on a total weight of the flux composition. In various embodiments, the dispersant is present in an amount of from 0 to about 0.5 wt %, about 0.1 to about 0.4, or about 0.2 to about 0.3 wt %, based on a total weight of the flux composition. In various non-limiting embodiments, all values and ranges of values including and between those set forth are expressly contemplated for use therein.

Suitable wetting agents may be any known in the art, including, but not limited to, Evonik: ZetaSperse®; BASF: Plurafac®, Lutensol®; Sasol: Marlox®, Marlipal®; KLK OLEO: Servoxyl®; Allnex: Additol®; etc. In one embodiment, the flux composition further includes Zetasperse® 1600. Suitable examples of defoamers include but not limited to EVONIK: Surfynol®; BASF: Degressal®, Pluriol®, FoamStar®, Foamaster®; BYK: Byk®-1711, Byk®-011, Byk®-016; etc. In one embodiment, the flux composition further includes Surfynol® 104. Suitable examples of biocide agents include but not limited to 2-phenoxyethanol, Thor: Acticide®; Lanxess: Prevento®; BASF: Protectol®; Clariant: Nipacide®, etc. In one embodiment, the flux composition further includes 2-phenoxyethanol and/or Plurafac LF 901.

The wetting agent may be present in an amount of from about 0 to about 0.5 wt %, based on a total weight of the flux composition. In various embodiments, the wetting agent is present in an amount of from 0 to about 0.5 wt %, about 0.1 to about 0.4, or about 0.2 to about 0.3 wt %, based on a total weight of the flux composition. In various non-limiting embodiments, all values and ranges of values including and between those set forth are expressly contemplated for use therein.

Similar to the binder and the thickening agent, the organic rheology additive may also be described as a non-volatile organic compound and may have a third carbon content. The third carbon content, which may be measured using any methods first mentioned above, may be from about 0 to about less than 1 wt %, based on a total weight of the flux composition, so long as the combination of the first, second, and third carbon content does not exceed 1 wt %, based on a total weight of the flux composition. In various embodiments, the third carbon content is from about 0 to about 0.9 wt %, about 0.05 to about 0.85 wt %, about 0.1 to about 0.8 wt %, about 0.15 to about 0.75 wt %, about 0.2 to about 0.7 wt %, about 0.25 to about 0.65 wt %, about 0.3 to about 0.6 wt %, about 0.35 to about 0.55 wt %, about 0.4 to about 0.5 wt %, based on a total weight of the flux composition. In various non-limiting embodiments, all values and ranges of values including and between those set forth are expressly contemplated for use therein.

The composition may further include, or be free of, a UV marker, which can be detected by light detectors, e.g. to control and/or facilitate flux printing deposition processes. The UV marker may be any known in the art. In various embodiments, the UV marker is or includes Rhodamin B. In other embodiments, the UV marker is or includes a dye that emits a fluorescent light at a wavelength that is equal to or greater than about 690 nm, as can be determined using any method known in the art. In various embodiments, the UV marker is present in an amount of from about 0 to about 0.1 wt %, alternatively from about 0 to about 0.05, about 0 to about 0.01, about 0.01 to about 0.05, about 0.05 to about 0.1, wt %, based on a total weight of the flux composition. In various non-limiting embodiments, all values and ranges of values including and between those set forth are expressly contemplated for use therein.

### Physical Properties of the Flux Composition:

The flux composition may have various physical properties, such as carbon content, solids content, viscosity, particle size, etc. Physical parameters of the flux composition may be customized in consideration of industrial needs and application techniques.

### Carbon Content:

The terminology “carbon content” or “organic content” refers to an amount of organic non-volatile carbon present in a non-volatile organic compound, indicated in wt %, based on a total weight of the compound. The flux composition includes non-volatile organic components such as the binder, the thickening agent, and optional organic rheology additives, which can contribute to the carbon content of the flux composition. The carbon content of the flux composition can be calculated as the weighed sum of all carbon contents of non-volatile organic components included in the flux composition. Alternatively, the carbon content of the flux composition may be measured using any of the methods first mentioned above, e.g. wet oxidation, combustion analysis, etc. In various embodiments, the carbon content of the flux composition is measured using combustion analysis.

The flux composition, measured using combustion analysis, has a carbon content of about 1 wt % or less. In various embodiments, the total carbon content of flux composition is from about greater than 0 and up to about 1 wt %, about 0.1 to about 0.9 wt %, about 0.2 to about 0.8 wt %, about 0.3 to about 0.7 wt %, or about 0.4 to about 0.6 wt %, based on a total weight of the flux composition. In various non-limiting embodiments, all values and ranges of values including and between those set forth are expressly contemplated for use therein.

A minimized carbon content helps reduce visible carbon black residues left behind on joints between metal substrates when the flux composition is used. The presence and amounts of these residues can be visually assessed by the naked eye. An increase in the carbon content of the flux composition typically leads to an undesirable increase in visible carbon black residue. The residues, when present, can also weaken the strength of the joint in addition to being unsightly. Accordingly, it is generally desirable for the flux composition to have a carbon content of about 1 wt % or less, based on a total weight of the flux composition, thereby reducing or eliminating the carbon black residue left on the surface of the metal article post brazing.

### Solids Content:

The terminology “solids content” refers to an amount of solid components in the flux composition, reported in wt %, based on a total weight of the flux composition. Solids content can be a helpful parameter in assessing performance of the flux composition. Solids content can be measured according to various standardized methods, e.g. ASTM C1603-16, ASTM D6866-20, IPC-TM-650, etc. Alternatively, the solids content may be measured using various apparatus, e.g. a halogen moisture analyzer which is a balance equipped with an IR-halogen heater. For example, the solids content may be measured by depositing two grams of the flux composition into an aluminum cup, which is placed on the balance with heating device. Subsequently, the weight is recorded, and the flux composition is heated until the weight loss is minimal, or a final weight loss. The solid content is calculated as the difference between 100 and the final weight loss, reported in wt %.

Generally, a large solids content can help increase the effectiveness of the flux composition, e.g. in removing oxides from the metal substrate. However, compositions having a large solids content, e.g. more than about 70 wt %, based on a total weight of the flux composition, may also include an increased amount of the organic rheology additive, such as the dispersant, to help avoid undesirable sedimentation, thereby increasing the carbon content of such compositions. In contrast, compositions having a lesser solids content, e.g. less than about 30 wt %, based on a total weight of the flux composition, may suffer from ineffective brazing performance.

Accordingly, the flux composition may have a solids content, measured using any of the aforementioned method, of from 30 to 70 wt %, based on a total weight of the flux composition. In various embodiments, the solids content is from about 30 to about 70 wt %, about 40 to about 70 wt %, or about 50 to about 60 wt %. In other embodiments, the solids content is from about 51 to about 59 wt %, about 52 to about 58 wt %, about 53 to about 57 wt %, or about 54 to about 56 wt %. In various non-limiting embodiments, all values and ranges of values including and between those set forth are expressly contemplated for use therein.

### Viscosity:

The viscosity of the flux composition may be customized to suit different industrial needs and application techniques. The viscosity may be measured using any standardized method known in the art, e.g. ISO 17025, ISO 17034, ASTM D445, etc. Various analytical instruments and apparatus may also be used, e.g. a rotary viscometer such as a Haake Viscotester IQ. In various embodiments, a Haake Viscotester IQ is used to measure the viscosity using various settings, e.g. using a FL100 rotor, at a sheer rate of about 23.5 s⁻¹, at a temperature of about 21° C., etc. However, the skilled person may change one or more parameters if desired. Any one or more viscosity values described herein may be determined using the aforementioned methods.

The viscosity of the flux composition is not particularly limited. In various embodiments, the viscosity of the flux composition may be from about 1000 to about 10,000 mPas. In some embodiments, the viscosity of the flux composition is from 1000 to about 6000 mPas, about 1500 to about 6000 mPas, about 2000 to about 6000 mPas, about 2500 to about 5500 mPas, about 3000 to about 5000 mPas, or about 3500 to about 4500 mPas. In various embodiments, the viscosity of the flux composition is from about 6000 to about 10,000 mPas, about 6500 to about 9500 mPas, about 7000 to about 9000 mPas, about 7500 to about 8500 mPas, or about 7500 to about 800 mPas. In other embodiments, the viscosity of the flux composition is from about 2000 to about 4000 mPas, about 2100 to about 3900 mPas, about 2200 to about 3800 mPas, about 2300 to about 3700 mPas, about 2400 to about 3600 mPas, about 2500 to about 3500 mPas, about 2600 to about 3400 mPas, about 2700 to about 3300 mPas, about 2800 to about 3200 mPas, or about 2900 to about 3100 mPas. In another embodiment, the viscosity is from about 2000 to about 2100 mPas, about 2010 to about 2090 mPas, about 2020 to about 2080 mPas, about 2030 to about 2070 mPas, or about 2040 to about 2060 mPas. The aforementioned viscosity can be measured according to the method set forth above. In various non-limiting embodiments, all values and ranges of values including and between those set forth are expressly contemplated for use therein.

### Particle Size:

As described above, the flux composition includes the flux agent, which may or may not be micronized to reduce particle size for different applications. The flux composition may additionally include other solid components, which may also independently have a certain particle size, similar to or different from, the particle size of the flux agent. Accordingly, the particle size of the flux composition may be the same as, or different from, the particle size of the flux agent after micronization.

The particle size of the flux composition can be determined using any apparatus known in the art, e.g. Horiba LA960V2 laser particle analyzer. In just one example, the setting of the Horiba LA960V2 may including: a particulate refractive index of 1.310-0.180i, a dispersant refractive index of about 1.333. However, the skilled person may change one or more parameters if desired. Any one or more particle size values described herein may be determined using the aforementioned methods.

The flux composition may have a Dv90 particle size of from about 5 to about 30 microns, about 6 to about 29 microns, about 7 to about 28 microns, about 8 to about 27 microns, about 9 to about 26 microns, about 10 to about 25 microns, about 11 to about 24 microns, about 12 to about 23 microns, about 13 to about 22 microns, about 14 to about 21 microns, about 15 to about 20 microns, about 16 to about 19 microns, or about 17 to about 18 microns as determined using one or more methods such as ASTM D5861, ISO 13320:2009, ISO 13320:2020, or the like. In various non-limiting embodiments, all values and ranges of values including and between those set forth are expressly contemplated for use therein.

### Methods of Making:

The flux composition may be made by combining the flux agent, the thickening agent, the binder, and the organic solvent. Alternatively, water and any additional organic rheology additive may also be combined. The step of combining may be performed using any known method or apparatus in the art e.g. a disperser, a mixer, a blender, a mill, a discharge system, a control system, a tank and/or a vessel. The step of combining may occur in an open or closed system, with or without agitation, in a single or multiple steps. One skilled in the art may choose an appropriate method of combining based on specific components in the flux composition and desired performance.

As first described above, in various embodiments, the flux agent is micronized to decrease the particle size for different applications, using methods such as mechanical milling, annular gap bead milling and the likes, before the step of combining. However, micronizing the flux agent alone may result in undesirable friction between milling beads used for micronization and the flux agent itself. Accordingly, the thickening agent, and the organic solvent, along with optional water, and/or any additional organic rheology additive can be combined with the flux agent to be micronized. However, certain micronization methods, e.g. annular gap bead milling, can generate heat, which may or may not degrade the thickening agent, and any additional organic rheology additives. To help mitigate this issue, these compounds may or may not be combined with the flux agent before the micronization process, in a total or a partial weight amount. The binder may degrade more easily and accordingly, may not be micronized.

For example, the thickening agent may be combined with the flux agent, the binder, the organic solvent and optionally water and/or any other rheology additives in a single step or in multiple steps, e.g. before and/or after the micronization process. In one embodiment, the thickening agent is combined with the flux agent before the micronization process. In another embodiment, the thickening agent is combined with the flux agent after the micronization process. In yet another embodiment, the binder is combined with the flux agent before and after the micronization process.

When the thickening agent is combined with the flux agent in multiple steps, an amount of about 5 to about 90 wt % of the thickening agent is typically combined with the flux agent pre-micronization, based on a weight of the total amount of the thickening agent. In various embodiments, about 5 to about 90 wt %, about 10 to about 85 wt %, about 15 to about 80 wt %, about 20 to about 75 wt %, about 25 to about 70 wt %, about 30 to about 65 wt %, about 35 to about 60 wt %, or about 40 to about 55 wt % of the thickening agent, based on a total amount of the thickening agent is combined with the flux agent pre-micronization.

The binder may be degraded during the micronization process. Accordingly, the binder may be combined with the flux agent, the thickening agent, the organic solvent, and optionally water, and/or any other rheology additives after the micronization process.

### Flux Paste:

The combination of the flux agents, thickening agent, water and/or additional rheology additives that have undergone the micronization process may be described as “flux paste”. The flux paste may not include the binder. In various embodiments, the flux paste includes the flux agent that is the combination of KAlF₄ and CsAlF₄, diutan gum, 3-Methoxy-3methyl-1-Butanol, Phenoxyethanol, Butyl glycol, Propylene carbonate, Plurafac LF901, PEG 400, water, Kelco Vis DG, Disperbyk 190 block copolymer, or combinations thereof.

Compounds that are combined with the flux paste after the micronization process may be referred to as “crude component”. The crude component may be the same or different from any compound included in the flux paste, e.g. the thickening agent, the binder, optional water, and/or optional rheology additives. In various embodiments, the crude component may be water, diutan gum, PEG 400, acrylic binder, Glycerin, modified ethylene/vinyl acetate copolymer, Phenoxyethanol, modified urea, Propylene carbonate, Polypropylene carbonate, weco-Fan binder, or combinations thereof.

For example, in various embodiments, the flux agent that is the combination of KAlF₄ and CsAlF₄ is combined with diutan gum, 3-Methoxy-3methyl-1-Butanol, Phenoxyethanol, Butyl glycol, Propylene carbonate, Plurafac LF901, PEG 400 and water to be micronized to form the flux paste. In other embodiments, crude components including additional water, diutan gum, and PEG 400, as well as acrylic binder, Glycerin, modified ethylene/vinyl acetate copolymer, Phenoxyethanol, and modified urea are combined with the flux paste to form the flux composition. In various non-limiting embodiments, different compositions of flux paste and crude components may be contemplated.

Accordingly, the flux composition may be alternatively described as including the flux paste and the crude component, which may be added to a total of 100 wt % of the flux composition. The flux paste may be present in the flux composition in an amount of from about 70 to about 99 wt %, based on a total weight of the flux composition. In various embodiments, the flux paste is present in an amount of from about 70 to about 99 wt %, about 71 to about 98 wt %, about 72 to about 97 wt %, about 73 to about 96 wt %, about 74 to about 95 wt %, about 75 wt % to about 94 wt %, about 76 to about 93 wt %, about 77 to about 92 wt %, about 78 to about 91 wt %, about 79 to about 90 wt %, about 80 to about 89 wt %, about 81 to about 88 wt %, about 82 to about 87 wt %, about 83 to about 88 wt %, about 84 to about 87 wt %, or about 85 to about 86 wt %, based on a total weight of the flux composition. In various non-limiting embodiments, all values and ranges of values including and between those set forth are expressly contemplated for use therein.

Accordingly, the crude component may be present in the flux composition in an amount of from about 1 to about 30 wt %, based on a total weight of the flux composition. In various embodiments, the crude component is present in an amount of from about 1 to about 30 wt %, about 2 to about 29 wt %, about 3 to about 28 wt %, about 4 to about 27 wt %, about 5 to about 26 wt %, about 6 to about 25 wt %, about 7 to about 24 wt %, about 8 to about 23 wt %, about 9 to about 22 wt %, about 10 to about 21 wt %, about 11 to about 20 wt %, about 12 to about 19 wt %, about 13 to about 18 wt %, about 14 to about 17 wt %, or about 15 to about 16 wt %, based on a total weight of the composition. In various non-limiting embodiments, all values and ranges of values including and between those set forth are expressly contemplated for use therein.

### Physical Properties of the Flux Paste:

Physical properties of the flux paste can be analyzed using similar methods as previously described for analyses of the flux composition. Compared to the flux composition, the flux paste is generally free of the crude compound. Accordingly, the flux paste may or may not have a similar physical property compared to the flux composition.

Regarding solids content, the flux paste may have a solids content of from about 45 to about 60 wt %, based on a total weight of the flux paste, measured using a halogen moisture analyzer as first described above. In various embodiments, the flux paste has a solids content of from about 45 to about 60 wt %, about 46 to about 59 wt %, about 47 to about 58 wt %, about 48 to about 57 wt %, about 49 to about 56 wt %, about 50 to about 55 wt %, about 51 to about 54 wt %, or about 52 to about 53 wt %, based on a total weight of the paste, measured according to the method set forth above. In various non-limiting embodiments, all values and ranges of values including and between those set forth are expressly contemplated for use therein.

Regarding viscosity, the flux paste may have a viscosity of from about 2500 to about 4500 mPas, measured according to the method set forth above. In various embodiments, the viscosity is from about 2500 to about 4500 mPas, about 2600 to about 4300 mPas, about 2700 to about 4200 mPas, about 2800 to about 4100 mPas, or about 2900 to about 4000 mPas. In various non-limiting embodiments, all values and ranges of values including and between those set forth are expressly contemplated for use therein.

Regarding carbon content, the flux paste may have a carbon content of from about 0.3 to about 1.6 wt %, calculated based on a total weight of the paste. In various embodiments, the total carbon content of paste is from about 0.3 to about 1.6 wt %, about 0.4 to about 1.5 wt %, about 0.5 to about 1.4 wt %, about 0.6 to about 1.3 wt %, or about 0.4 to about 0.6 wt %. In various non-limiting embodiments, all values and ranges of values including and between those set forth are expressly contemplated for use therein.

### System and Methods of Applying:

This disclosure also provides a method of applying the flux composition onto the substrate, the method including the steps of:
a) providing the substrate;
b) providing an applicator including a nozzle defining a nozzle orifice that has a nozzle diameter of from about 0.1 to about 2 mm;
c) providing the flux composition;
d) jetting the flux composition through the nozzle orifice and onto the substrate.

The flux composition may be applied onto the substrate using a variety of methods, e.g. spreading of the flux composition using tools such as a spatula, a brush, a cloth, or a toothpick, or jetting of the flux composition, e.g. using a jetting system. Jetting can be a precise and controlled method of applying the flux composition onto the metal substrates, which helps reduce waste and improve efficiency in manufacturing processes. The terminology “jet” or “jetting” generally refers to a type of printing technology that propels lines of the flux composition (continuous system) or droplets of the flux composition (contactless system) onto the substrate. In various non limiting embodiments, one or more steps, components, mechanisms, apparatuses, etc. as described in US10022744B2, US005368219A, US008708246B2, US008753713B2, US009314812B2, US010022744B2, US010953413B2, and US010272463B2, which are expressly incorporated by reference herein in various non-limiting embodiments, can be used.

### Step of Providing the Substrate:

Relative to the step of providing the substrate, any method of providing the substrate may be used. For example, the substrate may be procured from an in-house (internal) and/or external sources. Additionally, the substrate may be secured and/or stabilized onto a workstation using techniques known in the art, e.g. using a clamp-on vise, a bench-vise mounting plate, etc. The step of providing the substrate may further include cleaning or otherwise preparing the substrate for application of the flux composition, e.g. wiping the substrate with a towel, cleaning with known cleaning agents such as isopropanol, dusting using an electric duster, with compressed air or N₂ gas, scrubbing the substrate with a sponge, sanding or polishing the substrate, etc.

The substrate may be or include one, two or multiple (e.g. three and more) sections. When the substrate includes two or more sections, e.g. multiple component circuit boards, heat exchangers, etc., these sections may be positioned in any arrangement or configuration, e.g. in serial, in parallel, inclined at an angle to one another. The substrates may be provided in a variety of non-limiting shapes, such as a sheet, a bar, a ring, etc. The substrate may be or include metals such as copper, aluminum and alloys such as brass, cast iron, steel, aluminum alloys, etc., or various combinations of metal and/or metal alloy. Different components of the same substrate may include different metals and/or metal alloys. Additionally, the substrate may or may not be in contact with one or more parts that are non-metal, e.g. plastic, wood, stone, glass, ceramic, etc.

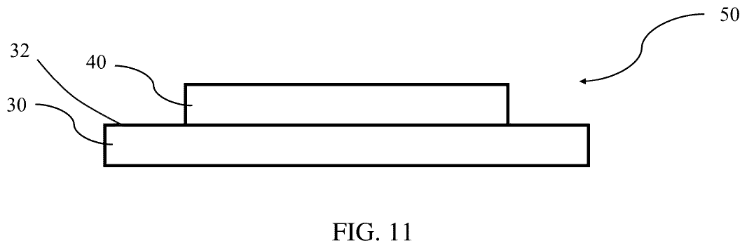

As shown in FIG. 11, the substrate (30) includes a surface (32). The substrate (30) may have a varying number of surfaces (32), e.g. one, two, three, etc. surfaces (32). The surface (32) can be accessible or positioned in such a way that is visible or exposed to the external environment, e.g. not attached to, or covered by, a different component or another substrate. The surface (32) of the substrate (30) may or may not have a metal oxide layer disposed thereon, formed from exposure to ambient oxygen.

### Step of Providing the Applicator:

Relative to the step of providing the applicator, any step known in the art may be used. The step of providing an applicator may be or include the step of commercially obtaining an applicator, assembling an applicator, modifying an existing applicator, installing an applicator, attaching an applicator to a jetting system, etc. A combination of the aforementioned steps may also be performed. Additionally, the step of providing the applicator may further include the step of preparing the applicator for jetting, e.g. setting appropriate jetting parameters, calibrating the applicator, cleaning components of the applicator, etc.

The applicator may be supplied as a part of, or separate from, a jetting system or device. The applicator may be configured in any arrangement. For example, the applicator may be attached to a robotic arm. Alternatively, the applicator may be a part of an array of applicators or a manifold system, where the flux composition is distributed to multiple applicators. Alternatively, the applicator may be incorporated in a module where the applicator and other components e.g. an actuator, a sensor, a regulator, etc. are housed together in a compact unit.

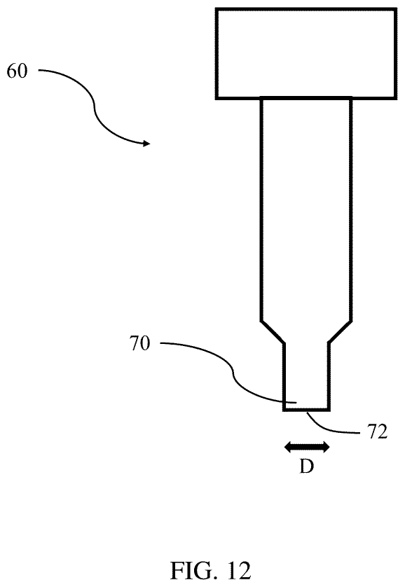

As shown in FIG. 12, the applicator (60) typically includes a nozzle (70) defining a nozzle orifice (72). The nozzle (70) is generally used for controlling flow and direction of the flux composition being jetted onto the surface (32) of the substrate (30). The nozzle (70) may be configured in various shapes, e.g. circular, conical, tapered, or in a specialized design, etc. The nozzle orifice (72) may be square, round, or irregular shaped, etc. The applicator (60) may have one, two, or multiple (three or more) nozzles (70). When multiple nozzles (70) are employed, these nozzles (70) may be arranged in a line, or arrayed to follow various shapes and patterns, spaced apart by various distances. A person skilled in the art may select the nozzle (70) appropriate for different jetting applications.

In various embodiments, the nozzle (70) is circular and has a diameter (D) of from about 1 to about 2 mm. In various embodiments, the nozzle (70) has a diameter (D) of from about 1 to about 2 mm, about 1.1 to about 1.9 mm, about 1.2 to about 1.8 mm, about 1.3 to about 1.7 mm, or about 1.4 to about 1.6 mm. In various non-limiting embodiments, all values and ranges of values including and between those set forth are expressly contemplated for use therein.

In other embodiments, the nozzle (70) is circular and has a diameter (D) of from about 0.1 to about 0.8 mm. In various embodiments, the nozzle (70) has a diameter (D) of from about 0.1 to about 0.8 mm, about 0.15 to about 0.75 mm, about 0.2 to about 0.7 mm, about 0.25 to about 0.65 mm, about 0.3 to about 0.7 mm, about 0.35 to about 0.65 mm, about 0.4 to about 0.6 mm, or about 0.45 to about 0.55 mm. In various non-limiting embodiments, all values and ranges of values including and between those set forth are expressly contemplated for use therein. For the sake of brevity, other components that may be present in the jetting systems may not be described in detail herein.

### Step of Providing the Flux Composition:

Regarding the step of providing the flux composition (40), any step known in the art may be employed. The flux composition (40) may be provided using a container, e.g. cartridge, jar, syringe, bottle, or directly deposited into the jetting system, e.g. into an integrated tank or reservoir. The step of providing the flux composition (40) may be further defined as distributing the flux composition to the applicator (60), using any mechanism known in the art. Non-limiting examples of such mechanisms include capillary action, gravity-fed, pressure-driven flow, pumping, or combinations thereof. The flux composition (40) may be provided continuously or in intervals, at a fixed rate, or in a gradient.

### Step of Jetting the Flux Composition:

The flux composition (40) is typically disposed on and in contact with the surface (32) of the substrate (30) or disposed on and spaced apart from the surface (32) of the substrate (30), by jetting the flux composition through the nozzle orifice (72) of the nozzle (70) and onto the surface (32) of the substrate (30). The step of jetting may be further described using parameters such as jetting frequency, jetting distance from the surface (32) of the substrate (30), jetting angle, etc.

For example, the flux composition (40) may be jetted onto the surface (32) of the substrate (30) at a jetting frequency of from about 100 to about 1,000,000 Hz. In various embodiments, the frequency is from about 100 to about 1,000,000 Hz, about 10,000 Hz to about 100,000 Hz, or about 30,000 Hz to about 60,000 Hz. In various other embodiments, the jetting frequency varies throughout the jetting process, e.g. when using burst mode. For example, a frequence of up to about 600 Hz may be used, e.g. about 500 Hz, about 400 Hz, about 300 Hz, etc. with a burst-mode frequency of up to about 1000 Hz, e.g. about 900 Hz, about 800 Hz, about 700 Hz, etc. In various non-limiting embodiments, all values and ranges of values including and between those set forth are expressly contemplated for use therein.

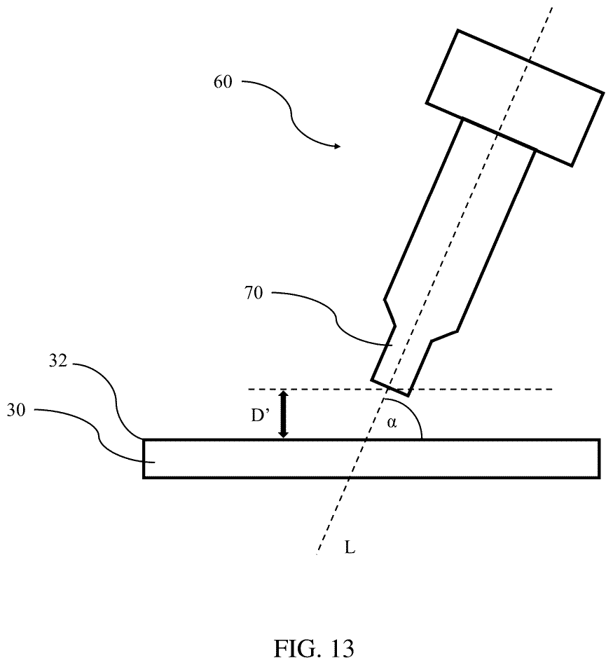

As shown in FIG. 13, the applicator (60) may be disposed or located a distance (D′) of from 1 to about 5 mm away from the surface (32) of the substrate (30). In various embodiments, the applicator (60) is located about 1 to about 5 mm, or about 2 to about 4 mm from the surface (32) of the substrate (30). In various non-limiting embodiments, all values and ranges of values including and between those set forth are expressly contemplated for use therein.

As shown in FIG. 13, the applicator (60) and/or a line of jetted flux composition may be disposed at an angle (α) defined by a plane (L) extended through the applicator (60) and the surface (32) of the substrate (30). The angle (α) is typically from about 10 to about 90 degrees. In various embodiments, the angle (α) of the applicator is from about 10 to about 90 degrees, about 20 to about 80 degrees, about 30 to about 70 degrees or about 40 to about 60 degrees. In various non-limiting embodiments, all values and ranges of values including and between those set forth are expressly contemplated for use therein.

The flux composition (40) can be applied to the surface (32) of the substrate (30) in burst mode. For each burst, an area of the surface (32) of the substrate (30) contacted by the flux composition (40) can be larger than the diameter (D) of the nozzle (70). For example, a burst of the flux composition (40) jetted through the nozzle (70) with the diameter (D) of about 0.3 mm may form a contacted area of from about 0.5 to about 1.5 mm, e.g. around 0.8 to about 1.2 mm, about 0.9 to about 1.1 mm, etc. In various non-limiting embodiments, all values and ranges of values including and between those set forth are expressly contemplated for use therein.

The applicator (60) may be configured to jet the flux composition (40) through the nozzle orifice (72) at an impact velocity of from about 0.2 m/s to about 20 m/s. In various embodiments, the applicator (60) may be configured to expel the flux composition (40) through the nozzle orifice (72) at an impact velocity of from about 0.2 m/s to about 20 m/s, about 2 to about 18 m/s, about 4 to about 16 m/s, about 6 to about 14 m/s, or about 8 to about 12 m/s. In various non-limiting embodiments, all values and ranges of values including and between those set forth are expressly contemplated for use therein.

The flux composition (40) may be expelled from the applicator (60) as droplets having a particle size of from about 100 to about 800 nm. The particle size of the droplets may be measured using any method known in the art, e.g. laser diffraction, photon correlation spectroscopy, Image Analysis VisiSizer technique, phase Doppler particle analysis, etc. In various embodiments, the particle size of the droplets is from about 100 to about 800 nm, about 200 to about 700 nm, or about 300 to about 600 nm. In various non-limiting embodiments, all values and ranges of values including and between those set forth are expressly contemplated for use therein.

In various embodiments, at least about 80% of the droplets of the flux composition (40) jetted from the applicator (60) contact the surface (32) of the substrate (30). In other embodiments, at least about 85%, alternatively at least 90%, alternatively at least 95%, alternatively at least 97%, alternatively at least 98%, alternatively at least 99%, or alternatively at least 99.9% of the droplets of the flux composition (40) jetted from the applicator (60) contact the surface (32) of the substrate (30). In various non-limiting embodiments, all values and ranges of values including and between those set forth are expressly contemplated for use therein.

In certain embodiments, at least 80% of the droplets of the flux composition (40) jetted from the applicator (60) are monodispersed such that the droplets have a particle size distribution of less than 20%. In other embodiments, at least 85%, alternatively at least 90%, alternatively at least 95%, alternatively at least 97%, alternatively at least 98%, alternatively at least 99%, or alternatively at least 99.9% of the droplets of the flux composition (40) jetted from the applicator (60) are monodispersed such that the droplets have a particle size distribution of less than 20%, alternatively less than 15%, alternatively less than 10%, alternatively less than 5%, alternatively less than 3%, alternatively less than 2%, alternatively less than 1%, or alternatively less than 0.1%. In various non-limiting embodiments, all values and ranges of values including and between those set forth are expressly contemplated for use therein.

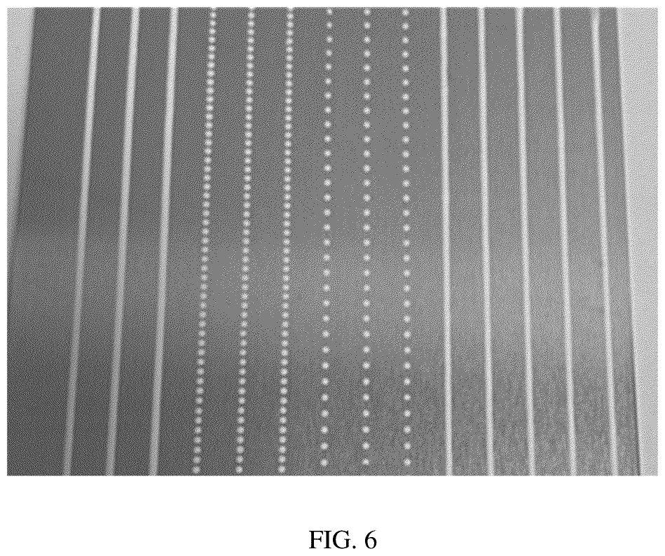

The flux composition (40) may be jetted onto the surface (32) of the substrate (30) in various shapes and patterns. In some embodiments, the flux composition (40) may be jetted onto the surface (32) of the substrate (30) in discrete dots, typically arranged in a line or an array, as shown in FIGS. 6, 7B, 8. The dots may be of any size or shape, e.g. oblong, round, etc. The dots may have various diameters, heights and/or distance, which may be measured using various methods, e.g. using a ruler, using a digital caliper, using an optical microscope, using a digital microscope, etc.

The dots typically have a diameter of from about 1 to about 3 mm. In various embodiments, the dots have a diameter of from about 1 to about 3 mm, about 1.1 to about 2.9, about 1.2 to about 2.8 mm, about 1.3 to about 2.7 mm, about 1.4 to about 2.6 mm, about 1.5 to about 2.5 mm, about 1.6 to about 2.4 mm, about 1.7 to about 2.3 mm, about 1.8 to about 2.2 mm, or about 1.9 to about 2.1 mm. In various non-limiting embodiments, all values and ranges of values including and between those set forth are expressly contemplated for use therein.

Additionally, the dots may have a height measured from the plane of the surface (32) of the substrate (30) of from about 0.1 to about 1 mm. In various embodiments, the dots may have a height of from about 0.1 to about 1 mm, about 0.2 to about 0.9 mm, about 0.3 to about 0.8 mm, about 0.4 to about 0.7 mm, or about 0.5 to about 0.6 mm. In various non-limiting embodiments, all values and ranges of values including and between those set forth are expressly contemplated for use therein.

The dots may be separated by a distance of from about 0 to about 1 m. In various embodiments, the distance between dots is from about 0 to about 1 m, about 0.1 to about 0.9 m, about 0.2 to about 0.8 m, about 0.3 to about 0.7 m, about 0.4 to about 0.6 m, or about 0.5 to about 0.6 m. In various non-limiting embodiments, all values and ranges of values including and between those set forth are expressly contemplated for use therein.

In various embodiments, the flux composition (40) may be jetted onto the surface (32) of the substrate (30) in a line, as shown in FIGS. 6, 7B, and 8. The line may be of any length, width, or height. The line may be straight or curved. The line may have various diameters, heights and/or length, which may be measured using various methods, e.g. using a ruler, using a digital caliper, using an optical microscope, using a digital microscope, etc.

The flux composition is typically printed in a line having a width of from about 0.5 to about 3 mm. In various embodiments, the line has a width of from about 0.5 to about 3 mm, about 0.6 to about 2.9 mm, about 0.7 to about 2.8 mm, about 0.8 to about 2.7 mm, about 0.9 to about 2.6 mm, about 1 to about 2.5 mm, about 1.1 to about 2.4 mm, about 1.2 to about 2.3 mm, about 1.3 to about 2.2 mm, about 1.4 to about 2.1 mm, about 1.5 to about 2.0 mm, about 1.6 to about 1.9 mm, or about 1.7 to about 1.8 mm. In various non-limiting embodiments, all values and ranges of values including and between those set forth are expressly contemplated for use therein.

Additionally, the line may have a height measured from the plane of the surface (32) of the substrate (30) of from about 0.1 to about 1 mm. In various embodiments, the line may have a height of from about 0.1 to about 1 mm, about 0.2 to about 0.9 mm, about 0.3 to about 0.8 mm, about 0.4 to about 0.7 mm, or about 0.5 to about 0.6 mm. In various non-limiting embodiments, all values and ranges of values including and between those set forth are expressly contemplated for use therein.

The flux compositions are typically printed in a line having a length of from about 0 to about 1 m, measured from the surface (32) of the substrate (30). In various embodiments, the line has a length of from about 0 to about 1 m, about 0.1 to about 0.9 m, about 0.2 to about 0.8 m, about 0.3 to about 0.7 m, about 0.4 to about 0.6 m, or about 0.5 to about 0.6 m. In various non-limiting embodiments, all values and ranges of values including and between those set forth are expressly contemplated for use therein.

### Additional Step:

The method of applying the flux composition (40) may further includes the step of brazing of the substrate (30), e.g. to connect different sections of the substrate (30), to connect different substrates (30) when multiple substrates (30) are present. The step of brazing may be performed using any tool or apparatus known in the art, e.g. a resistance brazing system, a brazing torch equipped with oxy-acetylene, propane, or MAPP gas, etc. The step of brazing may be performed at a temperature of from about 450 to about 900° C. In various embodiments, brazing is performed at about 450 to about 900° C., about 500 to about 850° C., about 550 to about 800° C., about 600 to about 750° C., or about 650 to about 700° C. In various non-limiting embodiments, all values and ranges of values including and between those set forth are expressly contemplated for use therein.

### Article:

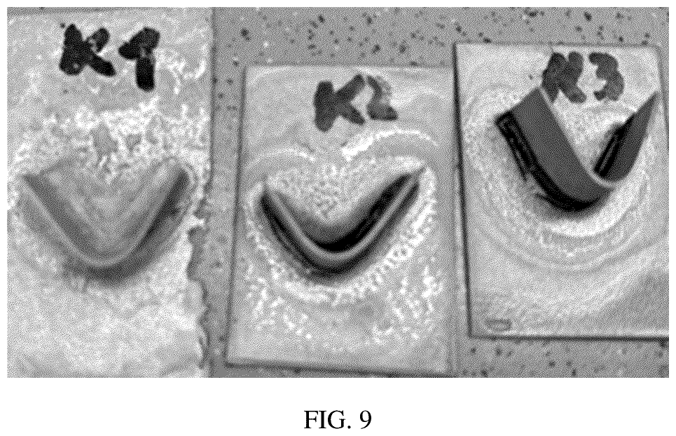

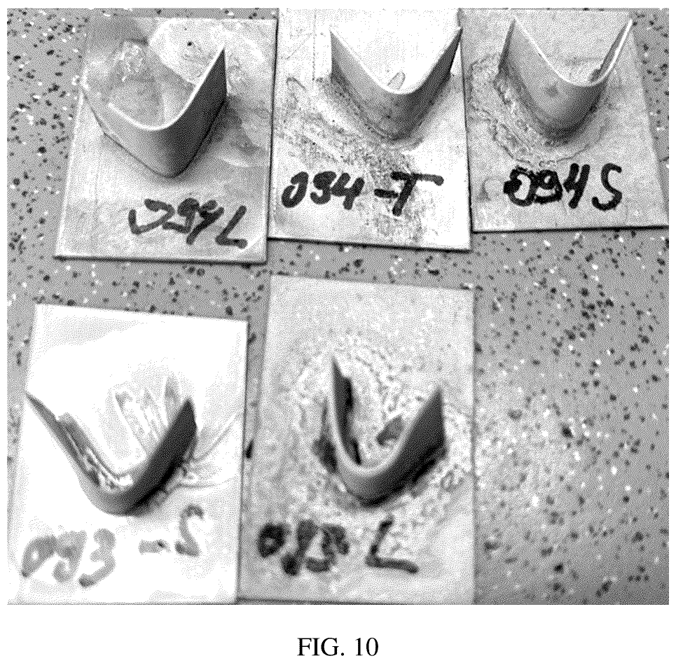

Referring back to FIG. 11, the flux composition (40) is typically disposed on and in and direct contact with the surface (32) of the substrate (30) to form an article (50), or disposed on and spaced apart from the surface (32) of the substrate (30). The article (50) may have any shape, similar to or different from the substrate (30), e.g. a sheet, a bar, a ring, etc. The article may include any pattern of the flux composition (40), as previously described, such as dots, lines, special designs, etc. The article may include the surface (32) of the substrate (30) completely covered by a layer of the flux composition (40). Alternatively, the article may include the surface (32) of the substrate (30) only partially covered by the flux composition (40). Furthermore, the article (50) may include one or more substrates (30), which may be positioned in any arrangement or configuration, e.g. in serial, in parallel, inclined at an angle to one another. Two or more substrates (30) of the article (50) may or may not be connected, temporarily or permanently, by a variety of different mechanisms, e.g. with a hinge, a rivet, by bolting, by using adhesive, etc. The article (50) may or may not further undergo a brazing process. Various non-limiting embodiments of the article (50) may be contemplated, for example, the articles shown in FIGS. 9 and 10.

### Performance Metrics of the Article:

The flux composition (40) has a minimized carbon content to help reduce visible carbon black residues left behind on the surface (32) of the substrate (30) when the flux composition is used. The flux composition (40) may or may not degrade and leave the surface (32) with a reduced amount of visible carbon black residue. Alternatively, the surface (32) may be free of visible carbon black residue after activation. Visible carbon black residue can be accessed qualitatively by the naked eye.

Alternatively, joints between the substrates (30) created in brazing processes may be tested to assess joint strength. Joint strength may increase with the decrease of visible carbon black residue. Typically, joint strength can be evaluated using a burst pressure resistance test performed at various pressures and temperatures. In various embodiments, the pressure resistance test is conducted at a pressure of from about 5 to about 10 bars, about 6 to about 9 bars, or about 7 to about 8 bars. In various non-limiting embodiments, all values and ranges of values including and between those set forth are expressly contemplated for use therein. In other embodiments, the pressure resistance test is conducted at a temperature of from about 25° C. to about 500° C., 25° C. to about 50° C., about 50 to about 100° C., about 100 to about 200° C., about 200 to about 300° C., about 300 to about 400° C., about 400 to about 500° C. In various non-limiting embodiments, all values and ranges of values including and between those set forth are expressly contemplated for use therein.

The joint may pass the burst pressure resistance test if it stays intact under a pressure of about 5 bars, alternatively of about 6 bars, alternatively of about 7 bars, alternatively of about 8 bars, alternatively of about 9 bars, alternatively of about 10 bars. In various non-limiting embodiments, all values and ranges of values including and between those set forth are expressly contemplated for use therein.

In jetting applications, the flux composition can further be described as related to printability, which generally describes the jetting performance of the flux composition (40) onto the surface (32) of the substrate (30). In contactless jetting systems, metrics including but not limited to dot symmetry, dot uniformity, dot weight etc. are typically considered.

In various embodiments, dot symmetry and dot uniformity are typically evaluated qualitatively using the naked eye. Typically, a consistent jetting performance may result in the dots appearing more symmetric and evenly filled. Average weight of dots, measured using 1000 dots, may also be used to describe the amount of flux composition (40) jetted onto the surface (32) of the substrate (30). The average weight of 1000 dots may be measured using any methods known in the art, e.g. using an analytical balance, using a digital scale, etc. For example, the average weight of 1000 dots may be calculated from subtracting the weight of the substrate (30) after 1000 dots are printed from the weight of the substrate before 1000 dots are printed. In various embodiments, the average weight of 1000 dots is from about 2000 to about 4000 mg, about 2100 to about 3900 mg, about 2200 to about 3800 mg, about 2300 to about 3700 mg, about 2400 to about 3600 mg, about 2500 to about 3500 mg, about 2600 to about 3400 mg, about 2700 to about 3300 mg, about 2800 to about 3200 mg, or about 2900 to about 3100 mg. In various non-limiting embodiments, all values and ranges of values including and between those set forth are expressly contemplated for use therein. Other methods of evaluating the dots and contactless printing performance known in the art may be employed.

In various embodiments, metrics including but not limited to line symmetry, line uniformity, etc. are typically considered to describe printing performance. These metrics may be evaluated using a similar or different method from the one employed in dot evaluation. For example, the line may be accessed for symmetry and uniformity, qualitatively by eye. Typically, a consistent jetting performance may result in the line appearing symmetric and evenly filled, exhibiting no visible gap or break in the line. The line may also be observed for any bumps, which may be visible and can indicate unevenness or lack of uniformity in the height of the line. Other methods of evaluating the line and traditional printing performance known in the art may be employed.

### EXAMPLES

### Effects of Physical Parameters of the Flux Agent and the Flux Composition:

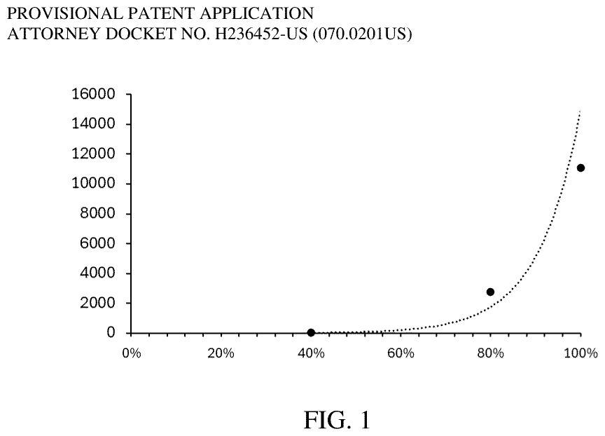

FIGS. 1, 2, 3, 4, and 5 illustrate relationships between physical parameters of the flux agent and the flux composition including viscosity, solids content, amount of flux agent, milling time, particle size, printing dot diameter and printing dot weight. These parameters are general considerations for the development of a printable flux composition with minimal carbon black residues.

FIG. 1 is a line graph and illustrates the effect of the solids content of a solution including KAlF₄ and water on the viscosity of the solution. The solids content of from about 40 to about 100 wt % is examined. The viscosity of the solution increases quickly from about 0 to about 11,000 mPas, with increasing solids content, as shown in FIG. 1.

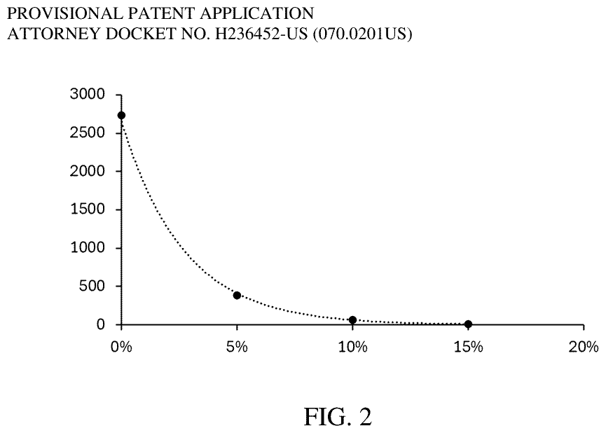

FIG. 2 is a line graph and illustrates the effect of adding CsAlF₄ into the solution including KAlF₄ and water on the viscosity of the solution. Surprisingly and unexpectedly, the viscosity of the solution decreases when CsAlF₄ is added. Specifically, an amount of CsAlF₄ of from 0 to about 15 wt % is examined. The viscosity of the solution decreases from about 2700 to about 0 mPas, with increasing CsAlF₄ amount.

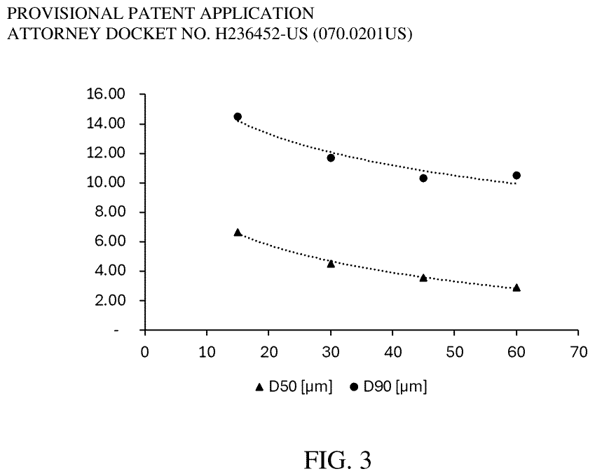

FIG. 3 is a line graph and illustrates the effect of milling time of a flux agent including KAlF₄ and CsAlF₄ on the particle size distribution (PSD) of the flux agent. Both Dv50 and Dv90 values of the flux composition decrease when CsAlF₄ is added. Specifically, an amount of CsAlF₄ of from 0 to about 15 wt % was examined. The viscosity of the flux composition decreases from about 2700 to about 0 mPas, with increasing CsAlF₄ amount.

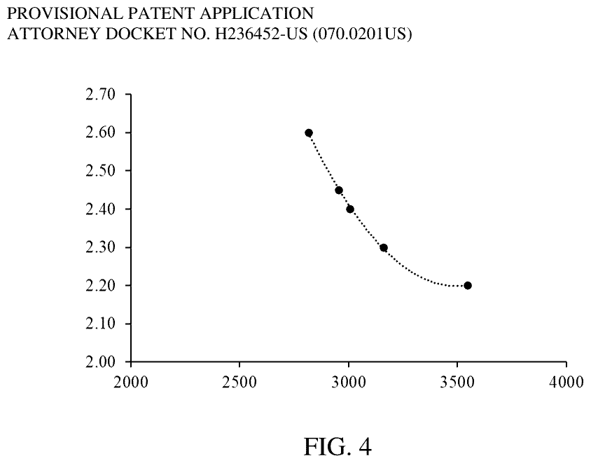

FIG. 4 illustrates the effect of viscosity of the flux composition 22 on the diameter of printed dots. The viscosity of the flux composition of from about 2800 to about 3600 mPas is examined. The diameter of the dots decreases with increasing viscosity. The diameter drops from about 2.6 to about 2.2 mm when the viscosity at 22.5/s shear rate increases from about 2800 to about 3600 mPas.

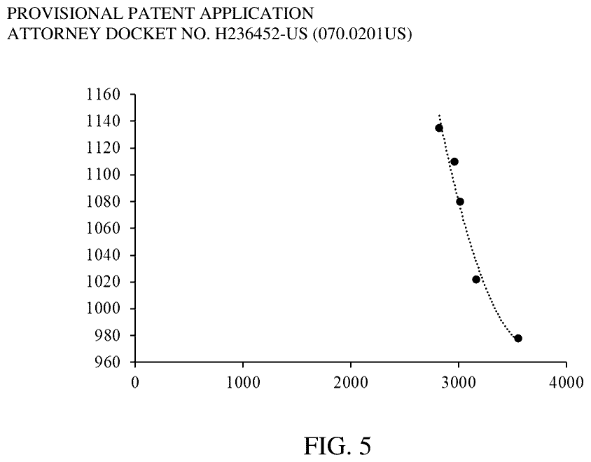

FIG. 5 is a line graph and illustrates the effect of viscosity of the flux composition 22 on the weight of printed dots, measured with 1000 dots, reported in mg, decreases with increasing viscosity. The weight of 1000 printed dots decreases from about 1140 to about 980 mg when the viscosity at 22.5/s shear rate increases from about 2800 to about 3600 mPas.

### List of Components:

The flux composition examples are formulated using the components listed in Table 1 which may be added at different stages of the formulation process. Some components are combined and micronized to form flux pastes, as listed in Table 2. Other components are subsequently combined with the flux paste, without undergoing the process of micronization, as listed in Table 4.

TABLE 1
Chemical components used to make the flux compositions.

| Compound | Chemical Formula | Item |
|---|---|---|
| KAlF₄ | | flux agent |
| CsAlF₄ | | flux agent |
| Thickener 1 | 1 wt % diutan gum | thickening |
| | | agent |
| Kelco Vis DG | 99 to 100 wt % diutan gum | thickening |
| | | agent |
| Alberdingk AC3600 | 35 wt % acrylic binder | binder |
| | in water | |
| weco-Fan binder | 17 wt % acrylic binder | binder |
| | in water | |
| Water | | |
| 3-Methoxy-3methyl-1- | | organic solvent |
| Butanol | | |
| Butyl glycol | | organic solvent |
| Propylene carbonate | | organic solvent |
| Aquacer 526 | modified ethylene/vinyl | crystallization |
| | acetate copolymer | inhibitor |
| Byketol PL | modified urea | crystallization |
| | | inhibitor |
| Glycerin | | crystallization |
| | | inhibitor |
| PEG 400 | low MW polyethylene | crystallization |
| | glycol | inhibitor |
| Polypropylene | | crystallization |
| carbonate | | inhibitor |
| Tween 20 | polyethylene glycol | crystallization |
| | sorbitan monolaurate | inhibitor |
| Disperbyk 190 | blockcopolymer | dispersant |
| Plurafac LF 901 | fatty alcohol alkoxylate | wetting agent |
| Phenoxyethanol | | biocide |

### Preparation of the Flux Paste;

Various components are combined in the Netzsch Laboratory Agitator Bead Mill LabStar to be micronized to form 14 different flux pastes. The name and amount of each components in each flux paste are listed in Table 2.

TABLE 2
Components of Flux Pastes.

| Flux Paste | A | B | C | D | E | F | G | H |
|---|---|---|---|---|---|---|---|---|
| KAlF₄ | 46.1 | 46.1 | 49.4 | 49.4 | 49.4 | 45.5 | 49.4 | 46.5 |
| CsAlF₄ | 15.4 | 15.4 | 2.6 | 2.6 | 2.6 | 15.5 | 2.6 | 15.5 |
| Thickener 1 | 1.0 | 1.0 | — | — | — | 0.8 | — | 0.8 |
| Kelco Vis DG | — | — | 0.2 | 1.2 | 2.2 | — | 0.2 | — |
| Phenoxyethanol | 0.2 | 0.2 | 0.2 | 1.2 | 2.2 | 0.1 | 0.1 | 0.1 |
| Propylene | 1.4 | 1.4 | 1.4 | 2.4 | 3.4 | 1.4 | 1.4 | 1.4 |
| carbonate | | | | | | | | |
| Plurafac LF901 | 0.2 | 0.2 | 0.1 | 0.1 | 0.1 | 0.2 | 0.2 | 0.2 |
| PEG 400 | 0.3 | 0.3 | 0.2 | 0.2 | 0.2 | 0.2 | 0.2 | 0.2 |
| Water | 35.5 | 35.5 | 46.0 | 46.0 | 46.0 | 36.3 | 46.0 | 35.3 |

| Flux Paste | I | K | L | M | N | O |
|---|---|---|---|---|---|---|
| KAlF₄ | 46.5 | 46.5 | 46.5 | 43.5 | 53.2 | 51.3 |
| CsAlF₄ | 15.5 | 15.5 | 15.5 | 14.5 | 2.8 | 2.7 |
| Thickener 1 | 0.8 | 0.8 | 0.8 | 10.0 | 9.0 | — |
| Kelco Vis DG | — | — | — | — | — | 0.2 |
| 3-Methoxy-3- | — | — | — | 2.5 | 2.0 | — |
| methyl-1- | | | | | | |
| butanol | | | | | | |
| Phenoxy-ethanol | 0.1 | 0.1 | 0.1 | — | 0.2 | 2.0 |
| Butyl glycol | — | — | — | 5.0 | 2.0 | 2.0 |
| Propylene | 1.4 | 3.4 | 3.4 | — | — | — |
| carbonate | | | | | | |
| Plurafac LF901 | 0.2 | 0.2 | — | — | — | — |
| Disperbyk 190 | 0.1 | — | — | — | — | — |
| Tween 20 | 0.1 | — | — | — | — | — |
| Water | 35.3 | 33.5 | 33.5 | 24.5 | 30.8 | 41.8 |

The components in Table 2 are combined and micronized together. Micronization is performed for about 5 to about 15 minutes at about 2000 rpm using the Netzsch Laboratory Agitator Bead Mill LabStar. A milling tube with a volume of 0.17 L is filled to 85% with grinding media in size 2.0 mm. Milling conditions such as milling time and spindle speed, and physical properties such as solids content, carbon content, viscosity and particle size are recorded in Table 3. The particle size of the flux pastes is reported using three values Dv10, Dv50 and Dv90, which are evaluated using methods as described above. Micronization of flux pastes B and L are reproduced in triplicates and duplicates, respectively.

TABLE 3
Milling conditions and physical properties of Flux Pastes.

| | | Solids | Carbon | Mill. | | Viscosity | | | |
|---|---|---|---|---|---|---|---|---|---|
| Flux | KAlF₄/ | Content | Content | Time | Rev | (mPas) | | | |
| Paste | CsAlF₄ | (wt %) | (wt %) | (min) | (rpm) | @22.5/s | Dv10 | Dv50 | Dv90 |
| A | 75/25 | 63.0 | 0.46 | 15 | 2000 | — | — | — | — |
| B | 75/25 | 61.5 | 0.46 | 15 | 2000 | — | 2.08 | 3.86 | 6.85 |
| B | 75/25 | 61.5 | 0.46 | 15 | 2000 | — | 1.81 | 3.75 | 9.65 |
| B | 75/25 | 61.5 | 0.46 | 15 | 2000 | — | 2.10 | 3.86 | 6.85 |
| C | 95/5 | 60.4 | 0.50 | 15 | 2000 | — | 3.00 | 8.58 | 12.54 |
| D | 95/5 | 60.4 | 0.50 | 15 | 2000 | — | 2.27 | 6.69 | 9.98 |
| E | 95/5 | 60.4 | 0.50 | 15 | 2000 | — | 2.60 | 6.59 | 9.79 |
| F | — | 62.0 | 0.38 | 10 | 2000 | 21830 | 5.63 | 7.65 | 10.35 |
| G | — | 64.0 | 0.37 | 10 | 2000 | 8047 | 5.60 | 7.61 | 10.28 |
| H | — | 64.0 | 0.37 | 7 | 2000 | 22190 | 5.88 | 8.08 | 11.10 |
| I | — | 65.0 | 0.26 | 7 | 2000 | 25140 | 5.78 | 7.87 | 10.77 |
| J | — | 66.0 | 0.52 | 15 | 2000 | 290 | 2.29 | 3.11 | 4.12 |
| K | — | 67.0 | 0.38 | 7 | 2000 | 67220 | 5.88 | 7.91 | 10.73 |
| L | 75/25 | 60.1 | 0.56 | 7 | 2000 | — | 4.97 | 7.32 | 10.7 |
| L | 75/25 | 60.1 | 0.70 | 7 | 2000 | — | 5.26 | 7.77 | 10.6 |
| M | 75/25 | 58.1 | 0.20 | 7 | 2000 | — | 4.81 | 7.2 | 11.3 |
| N | 95/5 | 56.1 | 0.31 | 7 | 2000 | — | 5.38 | 8.02 | 11.6 |
| O | 95/5 | 54.2 | 0.39 | 7 | 2000 | — | 5.15 | 7.63 | 11.2 |

### Preparation of the Flux Compositions:

The flux pastes described in Tables 2 and 3 are combined with various components, as listed in Table 4 below, to form different flux compositions. Physical properties of the flux compositions including viscosity, solids content and carbon content are also reported in Table 4.

TABLE 4
Components and physical properties of Flux Compositions.

| Flux Composition | 1 | 2 | 3 | 4 | 5 | 6 | 7 | 8 |
|---|---|---|---|---|---|---|---|---|
| Flux Paste | A | A | A | A | A | B | B | B |
| (wt %) | 96.00 | 96.00 | 96.00 | 94.00 | 94.00 | 98.64 | 97.64 | 99.29 |
| Water (wt %) | 1.12 | 1.12 | 1.12 | 2.72 | 2.72 | — | — | — |
| Thickener 1 | 2.32 | 2.32 | 2.32 | 2.12 | 2.32 | 1.00 | 1.00 | — |
| (wt %) | | | | | | | | |
| Weco-Fan | — | — | — | — | — | — | — | — |
| binder (wt %) | | | | | | | | |
| Alberdingk | 0.36 | 0.36 | 0.36 | 0.36 | 0.36 | 0.36 | 0.36 | 0.36 |
| AC3600 (wt %) | | | | | | | | |
| PEG 400 | 0.20 | — | — | 0.4 | — | — | 1.00 | — |
| Glycerin | — | 0.20 | — | — | 0.40 | — | — | — |
| Aquacer 526 | — | — | 0.20 | — | — | — | — | — |
| Tween 20 | — | — | — | — | — | — | — | 0.35 |
| Phenoxyethanol | — | — | — | 0.20 | 0.2 | — | — | — |
| Propylene | — | — | — | — | — | — | — | — |
| carbonate | | | | | | | | |
| (wt %) | | | | | | | | |
| Polypropylene | — | — | — | — | — | — | — | — |
| carbonate | | | | | | | | |
| (wt %) | | | | | | | | |
| Plurafac LF | — | — | — | — | — | — | — | — |
| 901 | | | | | | | | |
| Byketol PL | — | — | — | 0.2 | — | — | — | — |
| Viscosity | 5667 | 6063 | 6446 | 1881 | 3597 | 1748 | 1659 | 1737 |
| Solids Content | 63.10 | 62.90 | 63.10 | 62.20 | 61.60 | 62.11 | 61.49 | 61.51 |
| (wt %) | | | | | | | | |
| Carbon | 0.38 | 0.38 | 0.36 | 0.76 | 0.58 | 0.65 | 0.64 | 0.99 |
| Content (wt %) | | | | | | | | |
| Flux Composition | 9 | 10 | 11 | 12 | 13 | 14 | 15 | 16 |
| Flux Paste | C | D | E | F | G | H | I | J |
| (wt %) | 90.00 | 90.00 | 90.00 | 97.22 | 90.34 | 97.22 | 97.22 | 97.22 |
| Water (wt %) | — | — | — | — | — | — | — | — |
| Thickener 1 | 9.29 | — | — | 2.42 | 9.3 | 2.42 | 2.42 | 2.42 |
| (wt %) | | | | | | | | |
| Weco-Fan | — | — | — | — | — | — | — | — |
| binder (wt %) | | | | | | | | |
| Alberdingk | 0.36 | 0.36 | 0.36 | 0.36 | 0.36 | 0.36 | 0.36 | 0.36 |
| AC3600 (wt %) | | | | | | | | |
| PEG 400 | — | — | — | — | — | — | — | — |
| Glycerin | — | 0.20 | — | — | — | — | — | — |
| Aquacer 526 | — | — | — | — | — | — | — | — |
| Tween 20 | — | — | — | — | — | — | — | — |
| Phenoxyethanol | — | — | — | — | — | — | — | — |
| Propylene | — | — | — | — | — | — | — | — |
| carbonate | | | | | | | | |
| (wt %) | | | | | | | | |
| Polypropylene | — | — | — | — | — | — | — | — |
| carbonate | | | | | | | | |
| (wt %) | | | | | | | | |
| Plurafac LF | 0.15 | 0.15 | 0.15 | — | — | — | — | — |
| 901 | | | | | | | | |
| Byketol PL | — | — | 0.20 | — | — | — | — | — |
| Viscosity | 2540 | 2573 | 2594 | 3372 | 3459 | 2604 | 2834 | — |
| Solids Content | 47.64 | 47.84 | 47.82 | 60.43 | 47.22 | 60.43 | 60.43 | 58.5 |
| (wt %) | | | | | | | | |
| Carbon | 0.84 | 1.04 | 1.02 | 0.52 | 0.57 | 0.52 | 0.4 | 0.52 |
| Content (wt %) | | | | | | | | |

| Flux Composition | 17 | 18 | 19 | 20 | 21 | 22 |
|---|---|---|---|---|---|---|
| Flux Paste | K | L | L | M | N | O |
| (wt %) | 97.22 | 89.81 | 95.00 | 92.75 | 90.00 | 92.20 |
| Water (wt %) | — | 5.09 | 2.50 | 3.35 | — | — |
| Thickener 1 | 2.42 | 2.78 | 2.00 | 1.91 | 9.20 | 7.00 |
| (wt %) | | | | | | |
| Weco-Fan | — | 0.93 | 1.00 | 0.96 | 0.8 | 0.8 |
| binder (wt %) | | | | | | |
| Alberdingk | 0.36 | — | — | — | — | — |
| AC3600 (wt %) | | | | | | |
| PEG 400 | — | — | — | — | — | — |
| Glycerin | — | — | — | — | — | — |
| Aquacer 526 | — | — | — | — | — | — |
| Tween 20 | — | — | — | — | — | — |
| Phenoxyethanol | — | — | — | — | — | — |
| Propylene | — | 0.93 | — | — | — | — |
| carbonate | | | | | | |
| (wt %) | | | | | | |
| Polypropylene | — | 0.46 | — | 1.03 | — | — |
| carbonate | | | | | | |
| (wt %) | | | | | | |
| Plurafac LF | — | — | — | — | — | — |
| 901 | | | | | | |
| Byketol PL | — | — | — | — | — | — |
| Viscosity | 3333 | 4033 | 4137 | 3572 | 2783 | 3560 |
| Solids Content | 60.43 | 54.30 | 55.34 | 54.69 | 50.71 | 50.18 |
| (wt %) | | | | | | |
| Carbon | 0.52 | 0.56 | 0.24 | 0.70 | 0.31 | 0.39 |
| Content (wt %) | | | | | | |

### Jet Printing and Brazing Results:

FIGS. 6, 7, 8, 9, and 10 illustrate the results of printing and brazing tests performed using a variety of flux compositions, as described below.

In FIG. 6, flux composition 15 was jetted onto an aluminum substrate using a Nordson pico pulse jetter, using a Rising Time (RT) of 0.25 ms, a Delay Time (DT) of 0.8 ms, a Falling Time (FT) of 0.85 ms, a stroke value of 80%, a stroke voltage at 100 V, and cycle times at 10, 15, 20 and 5 ms. The printability of the flux composition is high, with dots and lines with different thicknesses printed.

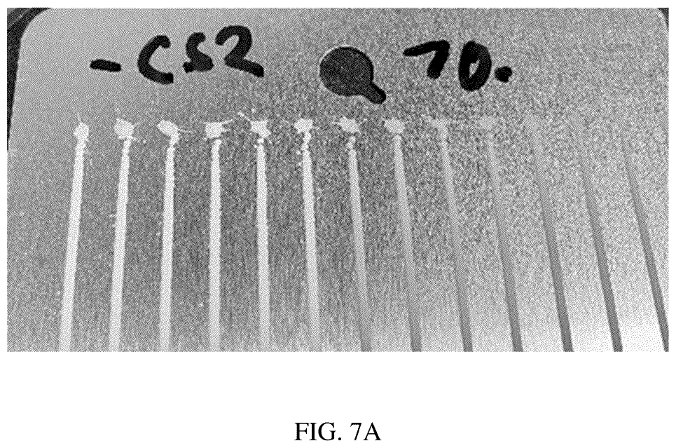

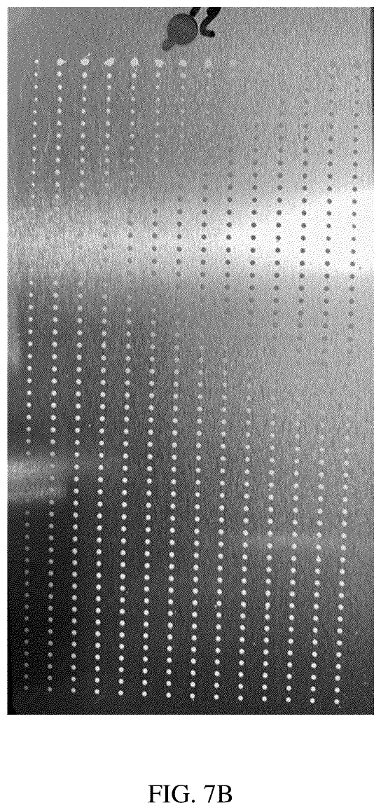

In FIG. 7, flux composition 16 was jetted onto an aluminum substrate using a Nordson pico pulse jetter, using an RT value of 0.25 ms, a DT value of 0.8 ms, an FT value of 0.85 ms, a stroke value of 90%, a stroke voltage at 110 V, and cycle time at 10 ms. The printability of the flux composition is high, with dots and lines with different thicknesses printed with high definition and uniformity. The flux composition dries quickly. Accordingly, the print nozzle was typically cleaned between settings or pauses. Composition 16 also has a high solids content. Accordingly, a higher stroke impulse and/or voltage was used.

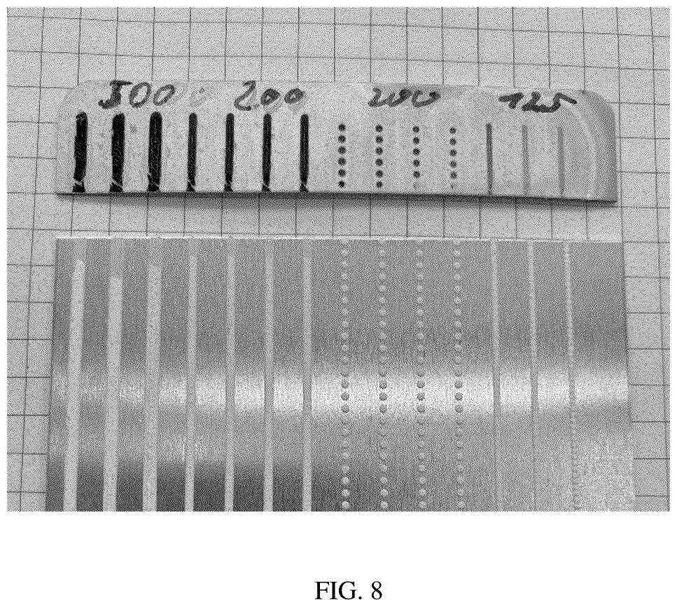

In FIG. 8, flux composition 22 was jetted onto an aluminum substrate using a Nordson pico pulse jetter, using an RT value of 0.25 ms, a DT value of 0.8 ms, an FT value of 0.85 ms, a stroke value of 90%, a stroke voltage at 110 V, and cycle time at 5, 2, 20 and 12.5 ms. The printability of the flux composition is high, with dots and lines with different thicknesses printed with high definition and uniformity.

The brazing performance of flux compositions 21 and 22 was tested on aluminum substrates. Brazing was performed with a 180° angle of clad sheets, 5 mm distance away from the substrate, and at 620° C. under an inert nitrogen atmosphere. Carbon black residue was visibly observed on the surface of the substrates post-brazing.

The flux compositions are further categorized into Generation 1 or 2, based on their components and the level of reduced carbon black residue. Generation 1 flux compositions including flux compositions 1 to 17 showed a reduction of the carbon black residues, but still visible, as illustrated in FIG. 9 Generation 2 flux compositions including flux compositions 18 to 22 utilized solvents and carbonate-including polymers and further showed no visible carbon black residue, as illustrated in FIG. 10, an improvement over flux compositions in Generation 1.

The inventive flux compositions exhibit good printing and brazing performance while significantly reducing the visible carbon black residue. By controlling the viscosity and other physical characteristics by optimizing the amount of cesium flux, the desired characteristics are achieved without adding a high amount of rheology additives, which greatly contribute to the carbon content. By further utilizing appropriate solvents and carbonate-including polymers as additives, Generation 2 flux compositions further eliminate the visible carbon black residue, improved upon Generation 1 flux compositions.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A flux composition comprising:
a flux agent that is a combination of KAlF₄ and CsAlF₄;
a thickening agent having a first carbon content;
a binder having a second carbon content; and
an organic solvent;
wherein a total carbon content of the flux composition is less than about 1 wt %, based on a total weight of the flux composition, measured using combustion analysis.

2. The flux composition of claim 1 wherein CsAlF₄ is present in an amount of from about 1 to about 30 wt %, based on a total weight of the KAlF₄ and CsAlF₄.

3. The flux composition of claim 1 wherein the thickening agent is chosen from cellulose ethers, polysaccharides, polyacrylates, and combinations thereof.

4. The flux composition of claim 1 wherein the thickening agent is present in an amount of from greater than about 0 and up to about 0.4 wt %, based on a total weight of the flux composition.

5. The flux composition of claim 1 wherein the binder is a polyacrylate.

6. The flux composition of claim 1 wherein the binder is present in an amount of from greater than about 0 and up to about 5 wt %, based on a total weight of the flux composition.

7. The flux composition of claim 1 having a solids content of from about 30 to about 70 wt %, based on a total weight of the flux composition.

8. The flux composition of claim 1 wherein the organic solvent is chosen from propylene carbonate, propylene glycol, hexylene glycol, dioxane, 3-methoxy-3-methyl-1-butanol, texanol, butyl glycol, butyl diglycol, butyl triglycol, and combinations thereof.

9. The flux composition of claim 1 wherein the organic solvent is present in an amount of from greater than about 0 and up to about 50 wt %, based on a total weight of the flux composition.

10. The flux composition of claim 1 having a viscosity of from about 1000 to about 4000 mPas, measured at a sheer rate of about 23.5 s⁻¹ and a temperature of about 21° C.

11. The flux composition of claim 1 wherein the flux agent has an average particle size distribution Dv90 of less than or equal to about 30 microns, as determined by laser diffraction.

12. The flux composition of claim 1 wherein the flux agent has an average particle size distribution Dv50 of less than or equal to about 30 microns, as determined by laser diffraction.

13. The flux composition of claim 1 wherein the flux agent has an average particle size distribution Dv10 of less than or equal to about 30 microns, as determined by laser diffraction.

14. The flux composition of claim 1 further comprising water.

15. The flux composition of claim 14 wherein water is present in an amount of from about 0 to about 50 wt %, based on a total weight of the flux composition.

16. The flux composition of claim 14 wherein water is present in an amount of from about 20 to about 50 wt %, based on a total weight of the flux composition.

17. A method of applying a flux composition onto a substrate, the method comprising:
a) providing the substrate;
b) providing an applicator comprising a nozzle defining a nozzle orifice that has a nozzle diameter of from about 0.1 to about 2 mm;
c) providing the flux composition comprising:
a flux agent comprising KAlF₄ and CsAlF₄;
a thickening agent having a first carbon content;
a binder having a second carbon content; and
an organic solvent;
wherein a total carbon content of the flux composition is less than about 1 wt %, based on a total weight of the flux composition, measured according to using combustion analysis; and
d) jetting the flux composition through the nozzle orifice and onto the substrate.

18. The method of claim 17 wherein the flux agent has an average particle size distribution Dv90 of less than or equal to about 30 microns, as determined by laser diffraction, and a viscosity of 1000 to about 4000 mPas, measured at a sheer rate of about 23.5 s⁻¹ and a temperature of about 21° C.

19. The method of claim 17 further comprising the step of brazing on the substrate to create a joint.

20. The method of claim 19 wherein the joint is free of visible carbon black residue after the step of brazing.
